(19) United States
(12) Patent Application Publication
(10) Pub. No.: US 2014/0377531 A1
(43) Pub. Date: Dec. 25, 2014

(54) OPTICAL ELEMENT, OPTICAL SYSTEM, AND OPTICAL APPARATUS

(71) Applicant: CANON KABUSHIKI KAISHA, Tokyo (JP)

(72) Inventor: Kazuhiko MOMOKI, Koshigaya-shi (JP)

(21) Appl. No.: 14/305,765

(22) Filed: Jun. 16, 2014

(30) Foreign Application Priority Data
Jun. 19, 2013 (JP) 2013-129006

(51) Int. Cl. G02B 1/11

(52) U.S. Cl. CPC G02B 1/115
USPC 428/313.3

(57) ABSTRACT

An optical element includes a substrate, and an antireflection film laminated on the substrate. The antireflection film includes, in order from the substrate side, a first layer including a plurality of dielectric thin films, a second layer including hollow particles bound by a dielectric material, and a third layer laminated on the second layer and made of a homogeneous dielectric. The hollow particles have an average particle diameter of 60 nm or less. A filling rate of the hollow particles in the second layer is 65% or higher.

### BACKGROUND OF THE INVENTION

1. Field of the Invention

The present invention relates to an optical element, an optical system, and an optical apparatus, each of which includes an antireflection film (or coating).

2. Description of the Related Art

Japanese Patent Laid-open No. (“JP”) 2012-108320 discloses an antireflection film having an improved antireflection characteristic by including nano-voids smaller than a wavelength in a medium of an uppermost layer (on the air side) and by lowering an effective refractive index (also referred to as a “graded refractive index”) through a proportion of air of the uppermost layer. More specifically, the uppermost layer contains hollow particles made, for example, of silica bound by a void-containing binder and is a low refractive index layer having a refractive index of 1.27 to 1.28 approximately.

The proportion of voids to the medium needs to be increased for a lower refractive index. The hollow particle has a high proportion of voids and there is a large amount of space between the particles. The refractive index can be made lower by increasing a void amount in the binder. When the void amount is set to be constant in the binder, a higher filling rate of the hollow particles provides a lower refractive index. It is therefore most effective to arrange the hollow particles in the hexagonal close-packed lattice or in the face-centered cubic lattice. In contrast, randomly distributed voids cause weak scattering, and a regularly arranged lattice that is smaller than a wavelength causes no scattering in principle. In other words, for a lower refractive index and reduced scattering, the hollow particles should be regularly arranged rather than randomly contained.

When the hollow particles are regularly arranged as disclosed in JP 2012-108320, the design freedom of the thickness of a hollow-particle layer impairs (although the number of hollow-particle layers is controlled). The general thin film designing requires controllability of 10 nm or less, but the film thickness control of about the diameter of the hollow particle or less is unavailable. In adjusting the diameter of the hollow particle, hollow particles of different diameters need to be arduously prepared according to a refractive index of a substrate.

### SUMMARY OF THE INVENTION

The present invention provides an optical element, an optical system, and an optical apparatus, each of which includes an antireflection film with a widely adjustable range of a thickness of a hollow-particle layer, reduced scattering, and a good antireflection characteristic.

An optical element according to the present invention includes an optical element that includes a substrate, and an antireflection film laminated on the substrate. The antireflection film includes, in order from the substrate side, a first layer including a plurality of dielectric thin films, a second layer including hollow particles bound by a dielectric material, and a third layer laminated on the second layer and made of a homogeneous dielectric. The hollow particles have an average particle diameter of 60 nm or less. A filling rate of the hollow particles in the second layer is 65% or higher.

Further features of the present invention will become apparent from the following description of exemplary embodiments with reference to the attached drawings.

### BRIEF DESCRIPTION OF THE DRAWINGS

FIG. 1 is a schematic sectional view of an optical element according to a first embodiment of the present invention.

FIGS. 2A and 2B are schematic views of hollow particles and a binder filled in a space formed by the hollow particles, respectively, in a hollow-particle layer illustrated in FIG. 1.

FIGS. 3A to 3I are schematic views of close-packed arrangements of the hollow particles.

FIGS. 4A to 4F are schematic views of low filling arrangements of the hollow particles.

FIGS. 5A to 5C are graphs of a relationship between L and h1′, a relationship between a filling rate and h1′, and a relationship between L and a thin film thickness in a low filling arrangement model, respectively.

FIG. 6 is a graph of a wavelength characteristic of a reflectance of an antireflection film according to the first embodiment.

FIGS. 7A and 7B are a schematic sectional view of an optical element according to a comparative example and a graph of a spectroscopic characteristic of a reflectance of an antireflection film according to the comparative example, respectively.

FIG. 8 is a schematic sectional view of an optical element according to a second embodiment of the present invention.

FIG. 9 is a graph of a wavelength characteristic of a reflectance of an antireflection film according to a second embodiment.

FIG. 10 is a graph of a wavelength characteristic of a reflectance of the antireflection film according to the second embodiment.

FIG. 11 is a graph of a wavelength characteristic of a reflectance of the antireflection film according to the second embodiment.

FIG. 12 is a graph of a wavelength characteristic of a reflectance of the antireflection film according to the second embodiment.

FIG. 13 is a graph of a wavelength characteristic of a reflectance of the antireflection film according to the second embodiment.

FIGS. 14A and 14B are a schematic sectional view of an optical element and a graph of a spectroscopic characteristic of a reflectance of an antireflection film, respectively, according to a third embodiment of the present invention.

FIGS. 15A and 15B are a schematic sectional view of an optical element and a graph of a spectroscopic characteristic of a reflectance of an antireflection film, respectively, according to a fourth embodiment of the present invention.

FIGS. 16A and 16B are a schematic sectional view of an optical element and a graph of a spectroscopic characteristic of a reflectance of an antireflection film, respectively, according to a fifth embodiment of the present invention.

### DESCRIPTION OF THE EMBODIMENTS

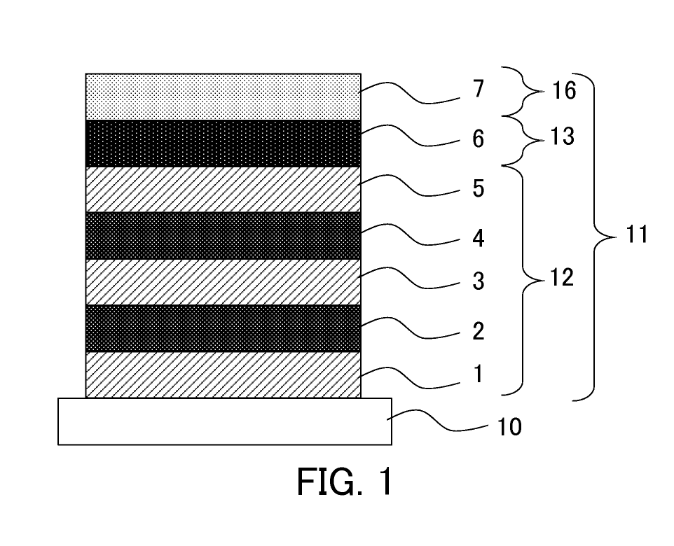

FIG. 1 is a schematic sectional view of an optical element according to a first embodiment of the present invention, which will be described later. A description will now be given of characteristics of the present invention common to each embodiment by using FIG. 1. An optical element according to the present invention includes a substrate 10, and an antireflection film 11 laminated on the transparent substrate 10. The antireflection film 11 includes a multilayer film layer (first layer) 12, a hollow-particle layer (second layer) 13, and a film thickness coordination layer (third layer) 16 in order from a layer closest to the substrate 10 in a direction going away from the substrate 10.

The multilayer film layer 12 includes a plurality of dielectric thin films and has a five-layered structure in FIG. 1. However, the number of layers is not limited. In FIG. 1, the multilayer film layer 12 includes a first layer 1, a second layer 2, a third layer 3, a fourth layer 4, and a fifth layer 5 in order from a layer closest to the substrate 10 in a direction going away from the substrate 10.

Each layer in the multilayer film layer 12 is formed by the evaporation and sputtering. The hollow-particle layer 13 is layered on the multilayer film layer 12. The hollow-particle layer 13 is a layer in which hollow particles are regularly arranged and bound by a binder. In FIG. 1, it is illustrated as a sixth layer 6. The film thickness coordination layer 16 is laminated on the hollow-particle layer 13 and configured as a seventh layer 7 made of a homogenous dielectric material. The film thickness coordination layer 16 serves to coordinate a film thickness. The dielectric is made, for example, of silica (SiO₂). The film thickness coordination layer 16 coats the hollow-particle layer 13 and effectively improving the mechanical strength. The film thickness coordination layer 16 is densely formed by the evaporation and sputtering, and improves the surface abrasion resistance. The slipping resistance of the film thickness coordination layer 16 is reduced by improving the surface smoothness.

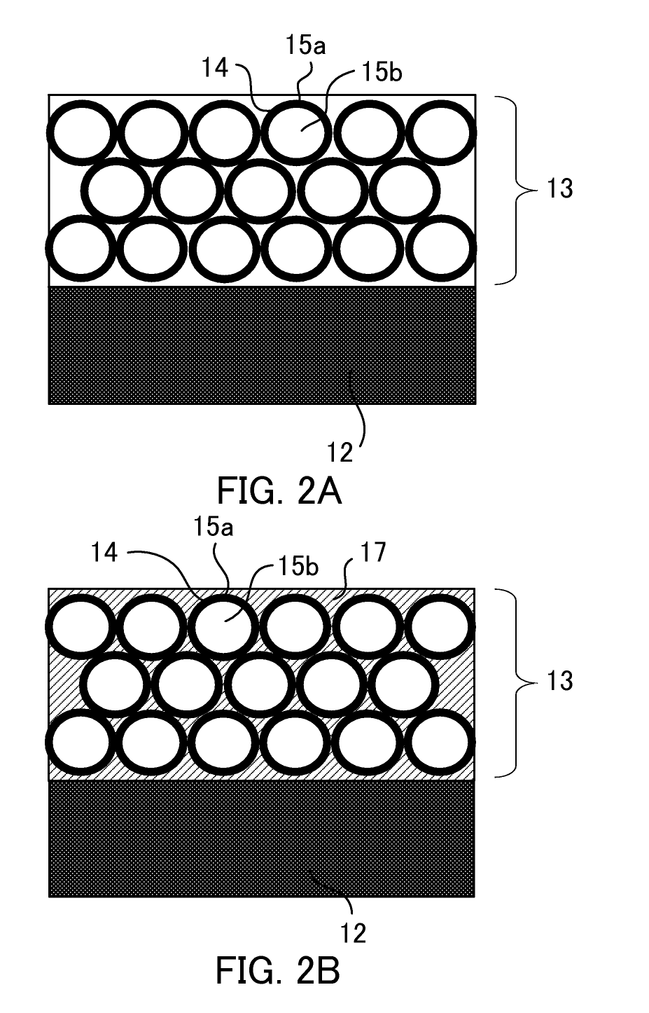

FIG. 2A is a schematic view of hollow particles 14 arranged in the hollow-particle layer 13, and FIG. 2B is a schematic view of a binder 17 filled in the space formed by the hollow particles 14.

The hollow-particle layer 13 contains the hollow particles bound by the dielectric material. The hollow-particle layer 13 contains one or more layers of the hollow particles 14. Each hollow particle 14 is a nano-particle having an outer shell 15a and an inner cavity 15b. The nano-cavity 15b is smaller than a wavelength and realizes a low refractive index layer having a refractive index of 1.3 or less. The outer shell 15a is made, for example, of silica (SiO₂) or MgF₂, and has a thickness of about 2 to 8 nm and an average particle diameter between 10 nm and 70 nm, inclusive. In order to reduce scattering, the average particle diameter may be 60 nm or smaller. A smaller average particle diameter is better. For a low refractive index, a ratio of the cavity 15b should be between 30% and 70%, inclusive, more preferably, between 50% and 70%, inclusive. Where a thickness of the outer shell 15a cannot be reduced, the average particle diameter may be about 30 nm. While this embodiment sets the average particle diameters of a plurality of the hollow particles equal to one another, the average particle diameters may be scattered. While a plurality of the hollow particles are regularly arranged, they can be randomly arranged as long as scattering can be ignored.

For a refractive index of 1.25 using silica (with a refractive index 1.46), an air content rate of about 50% is necessary. In the close-packed arrangement of the hollow particles 14, a space filling rate of the hollow particles 14 becomes about 74%. A filling rate of the hollow particles 14 in the hollow-particle layer 13 may be 65% or higher. The filling rate is 100% or lower.

When it is assumed that the rest of 36% is filled by the binder 17, a porosity V of the hollow particles 14 of about 68% is necessary. The hollow-particle layer 13 is formed by mixing the hollow particles 14 in a solvent using the spin coating method or the dip coating method. It is formed by coordinating and optimizing a solvent concentration and a coating condition and by arranging the hollow particles 14.

As illustrated in FIG. 2A, the hollow particles 14 are arranged in a close-packed state in a narrow area. Depending on the coating condition, the hollow particles arrange by themselves and form a regular arrangement. Particles of 60 nm or less cause no diffractions in the visible light but cause scattering light when they are randomly arranged. A regular arrangement can reduce the scattering light. The arranged hollow particles 14 form a laminated structure of 2 to 3 layers. By coating the binder 17 such as silica using the sol-gel method and binding the space in the hollow particles by the binder 17, as illustrated in FIG. 2B, the arrangement of the hollow particles 14 is fixed and the strength is secured.

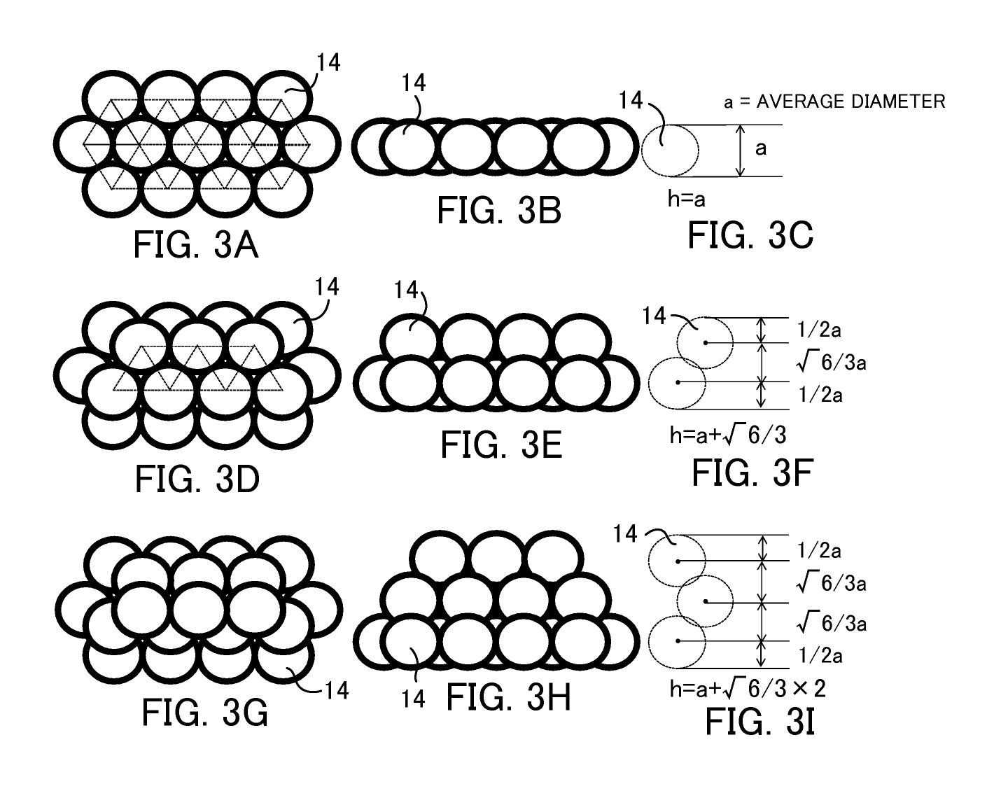

FIGS. 3A to 3I are views of the close-packed arrangement of the hollow particles 14.

FIGS. 3A to 3C illustrate the hollow particles 14 of a first layer closest to the substrate (the multilayer film layer 12) in the hollow-particle layer 13, arranged on the interface of a base evaporation film. FIG. 3A is a top view of the arrangement. Each hollow particle 14 is arranged in hexagonal directions and the distance between centers of the adjacent hollow particles 14 is the average diameter a of the hollow particle 14. FIG. 3B is a side view of the structure illustrated in FIG. 3A. The thickness h of the first layer can be approximated to the average diameter a, as illustrated in FIG. 3C that is a side view of one hollow particle 14.

FIGS. 3D to 3F illustrate the hollow particles 14 of a second layer arranged on the first layer. FIG. 3D is a top view of the arrangement, and the hollow particles 14 of the second layer are arranged so that each center is located above the center of three hollow particles adjacent to one another of the first layer. FIG. 3E is a side view of the structure illustrated in FIG. 3D and the thickness h of the laminated structure can be approximated to a+√6/3 a, as illustrated in FIG. 3F that illustrates a positional relationship of the hollow particles 14 of the first and second layers.

FIGS. 3G to 3I illustrate the hollow particles 14 of a third layer arranged on the second layer. FIG. 3G is a top view of the arrangement, and each hollow particle 14 of the third layer is arranged so that the center is located above the center of three hollow particles adjacent to one another of the second layer. FIG. 3H is a side view of the structure illustrated in FIG. 3G and the thickness h of the laminated structure (the thickness of the hollow-particle layer 13) can be approximated to a+√6/3 a×2, as illustrated in FIG. 3I that illustrates a positional relationship of the hollow particles 14 of the first to third layers.

When there are n layers (n is a natural number) of hollow particles 14, the thickness h of the hollow-particle layer 13 can be expressed as:

h=a+√6/3a×n(n=1,2,3, . . . ) (1)

As described above, in the close-packed arrangement of the hollow particles 14, the thickness h is a discrete value corresponding to the number of layers of hollow particles 14. The filling rate of the close-packed arrangement is about 74%. If a filling rate of the hollow particles 14 is lowered below this rate, the above thickness can be reduced.

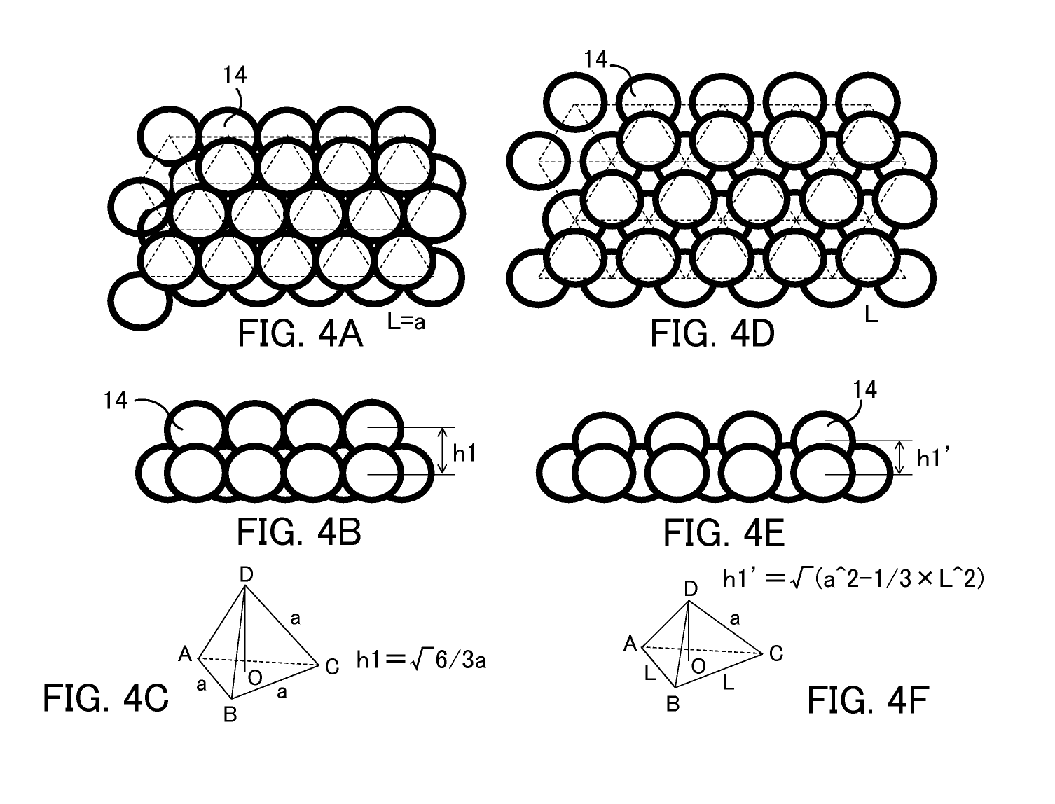

Referring now to FIGS. 4A to 4F, a description will be given of an adjustable thickness of the hollow particles 14.

FIG. 4A is a top view of an arrangement in a plane (the substrate plane) in the close-packed hollow particles 14. The distance L between the adjacent hollow particles is equal to the diameter a of the hollow particle and the hollow particles are closely arranged. FIG. 4B is a side view of the structure illustrated in FIG. 4A. The hollow particles 14 of the second layer are arranged so that each hollow particle contacts three hollow particles 14 of the first layer. The center positions of the four hollow particles form vertices of a regular tetrahedron illustrated in FIG. 4C. The film thickness h of the first layer is equal to a. The additional film thickness h1 of the second layer is, as illustrated in FIG. 4B, the height between the center of the first layer and the center of the second layer. It is expressed by h1=√6/3 a because it is the height of the regular tetrahedron in FIG. 4C.

FIGS. 4D, 4E, and 4F illustrate an arrangement of the hollow particles 14, whose filling rate is made slightly lower than that of the close-packed arrangement. FIG. 4D is a top view of this arrangement, and FIG. 4E is a side view of this arrangement. In the arrangement illustrated in FIG. 4D, the center distance L between the hollow particles 14 is larger than the diameter a of the hollow particles 14. As illustrated in FIG. 4E, the hollow particles 14 of the second layer is lower than that illustrated in FIG. 4B. As illustrated in FIG. 4F, the tetrahedron which illustrates the centers of the four hollow particles has a lower height. The additional film thickness h1′ can be expressed as follows:

h1′=√(a²−1/3×L²) (2)

With the foregoing in mind, the following expressions may be satisfied:

$$\begin{matrix}0.80 \leq {h}_{1} / ( a + \frac{\sqrt{6}}{3} a \times n ) \leq 1.10 & ( 3 ) \\ 5 ( nm ) \leq {h}_{2} \leq \frac{\sqrt{6}}{3} a & ( 4 )\end{matrix}$$

where a is the average particle diameter of the hollow particles 14, h1 is the thickness of the hollow-particle layer 13, h2 is the thickness of the film thickness coordination layer 16, and n is a natural number (n=1, 2, 3 . . . ). The expression (3) expresses a shift range from the expression (1) when the filling rate is lowered.

The lower limit of the expression (4) may be expressed by the following expression with the average particle diameter a.

$$\frac{a}{4} \leq {h}_{2} \leq \frac{\sqrt{6}}{3} a \qquad ( 5 )$$

In general, since the thickness of about half of the average particle diameter a (about a/2) is usually enough for a film thickness coordination of h₂, the expression (5) may be expressed as follows:

$$\frac{a}{2} \leq {h}_{2} \leq \frac{\sqrt{6}}{3} a \qquad ( 6 )$$

When it is assumed that R is a filling rate of the hollow particles 14, the following expression may be satisfied:

$$0.95 \leq {h}_{1} / ( a + \frac{\sqrt{6}}{3} a \times n \times ( 1 + 0.7054 \times ( R - 0.74 ) ) ) \leq 1.05 \qquad ( 7 )$$

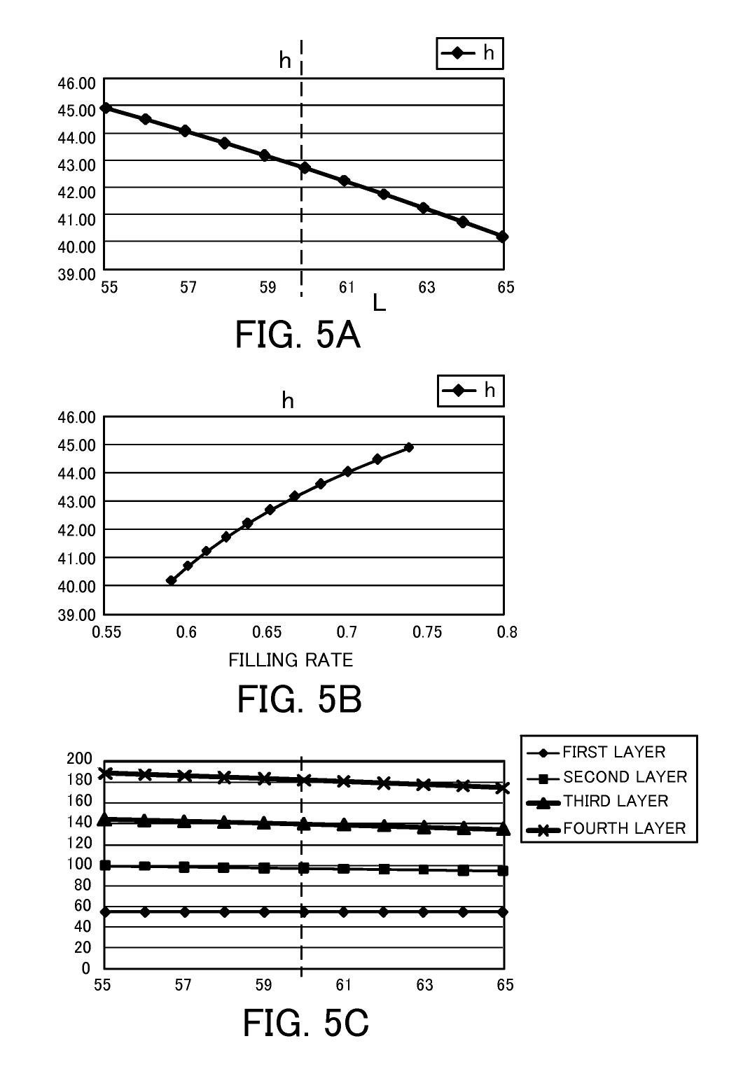

The expression (7) narrows a range between the upper limit and the lower limit in the expression (3) by multiplying a shift from 0.74 (74%) as the maximum value of R by a coefficient 0.7054 obtained from graphs in FIGS. 5A to 5C, which will be described later.

When it is assumed that n1 is a refractive index of the hollow-particle layer 13 for a wavelength of 550 nm and n2 is a refractive index of the film thickness coordination layer 16 for a wavelength of 550 nm, the following expression may be satisfied:

100 (nm)<n1×h₁+n2×h₂<150 (nm) (8)

The expression (8) expresses a value of n1·h₁+n2·h₂ is maintained near λ/4 (λ=550 nm) to keep the antireflection characteristic.

The self-arrangement of the hollow particles does not automatically provides the arrangement illustrated in FIG. 4D but the film thickness can be reduced by applying the pressure in the thickness direction after the closely-packed arrangement is formed and by spreading the arrangement interval.

In this model where the average diameter a of the hollow particles 14 is set to 55 nm, FIG. 5A is a graph of a relationship between the center distance L between the hollow particles 14 in the planar arrangement and an additional film thickness h₁. A filling rate is about 65% when L is about 60 nm. It is actually difficult to achieve a low filling rate of 65% or less while the arrangement is maintained because even a body-centered cubic lattice has a filling rate of 68%. In other words, when the limit for the regular arrangement is 65%, it can be considered to be the scattering restraining limit.

FIG. 5B is a graph of an additional film thickness h₁ for a filling rate. When the filling rate is 65%, h₁ becomes about 43 nm. The filling rate in the close-packed state is 74% and h₁ becomes about 45 nm.

FIG. 5C is a graph of a filling rate (%) (abscissa axis) and a total value of a film thickness (ordinate axis) when the number of layers of hollow particles 14 changed from one to four by extending this model. While the film thickness slightly reduces as the filling rate changes, a variable ratio of the film thickness is about 10%. Therefore, when the hollow particles each having a diameter of 55 nm are arranged and laminated, an available film thickness becomes discrete even when the filling rate is reduced.

Generally, in the antireflection film, the uppermost layer located at the air side is made of a medium with a low refractive index and is about ¼ as thick as the wavelength. However, an accurate film thickness control with a precision of 10 nm or less is required for each refractive index of a substrate and for each film configuration. Since the thickness control of the hollow-particle layer 13 depends upon the average diameter of the hollow particle 14, the diameter of the hollow particle needs to be determined for each film thickness design value. Preparing many hollow particles requires many solutions and many coating conditions for them in addition to causing a disadvantageous increase of the management cost.

This embodiment handles many design values only with limited kinds of diameters of the hollow particles 14 by arranging the film thickness coordination layer 16 on the hollow-particle layer 13 (on the air side). This embodiment limits a type of solution as well, and can realize stable coating under the same condition.

Concrete designing corresponding to a refractive index of a substrate glass material will be described in a second embodiment.

After the hollow particles 14 are applied, they need to be bounded by the binder 17. A device on which the hollow particles are applied by the sol-gel method is coated by the spin coat method with a solution for the binder and is dried. After drying, a binding force is improved by burning. Drying and burning may be performed by a dehydrator, a hot plate, an electric furnace, and so on. In general, a temperature of 300° C. or lower may be used. Coating once is usually enough, but drying and coating may be repeated plural times. The film thickness coordination layer 16 is formed by evaporation coating and sputtering, or formed by the method of coating the binder 17. The film thickness coordination layer 16 may be formed simultaneously with the binder 17. In other words, the film thickness coordination layer 16 can be formed either by a dry process or by a wet process. Whether the film thickness coordination layer 16 is formed by the dry process or by the wet process can be identified by a microscope, or the like.

### First Embodiment

An optical element according to a first embodiment has the same configuration as that illustrated in FIG. 1. The seven-layered antireflection film 11 is laminated on the substrate 10 as a glass substrate having a refractive index of 1.52. Hereinafter, values of a refractive index and an optical film thickness are obtained for λ of 550 nm.

Table 1 shows design values of the antireflection film 11 according to the first embodiment. The multilayer film layer 12 including the first layer 1 to the fifth layer 5 is formed by the evaporation method. The sixth layer 6 (the hollow-particle layer 13) uses SiO₂ for the outer shell 15a in the hollow particle 14, the hollow particles 14 has an average diameter of is 43.0 nm, and the layers are laminated in the close-packed state. The binder 17 is mainly composed of SiO₂ and fills the space in the hollow particles 14. The hollow-particle layer 13 has a refractive index of about 1.25 and a thickness of about 112.3 nm. After the binder is applied, the strength is enhanced by heating it in an oven. The seventh layer 7 (the film thickness coordination layer 16) is formed by evaporating silica.

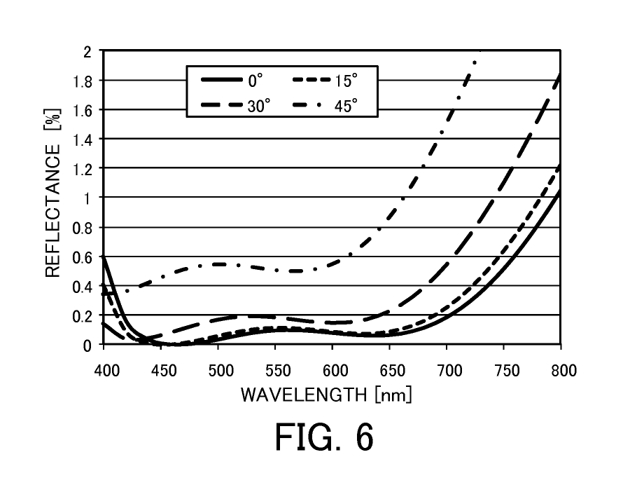

FIG. 6 is a graph of a wavelength characteristic of a reflectance of the antireflection film according to the first embodiment, and illustrates simulation results with incident angles of 0°, 15°, 30°, and 45° in a wavelength range of 400 nm to 800 nm. In a wavelength range of 420 nm to 700 nm, the reflectance with an incident angle of 0° is 0.2% or less and a high-performance antireflection characteristic is obtained. The reflectance with the incident angle of 30° is also 0.6% or less with a good angle characteristic.

TABLE 1

| | refractive index | optical film |
|---|---|---|
| | (550 nm) | thickness (nm) |
| seventh layer | 1.48 | 15.0 |
| sixth layer | 1.25 | 112.3 |
| fifth layer | 1.48 | 12.3 |
| fourth layer | 2.10 | 23.3 |
| third layer | 1.65 | 121.8 |
| second layer | 2.10 | 30.4 |
| first layer | 1.65 | 144.4 |
| substrate layer | 1.52 | |

### Comparative Example

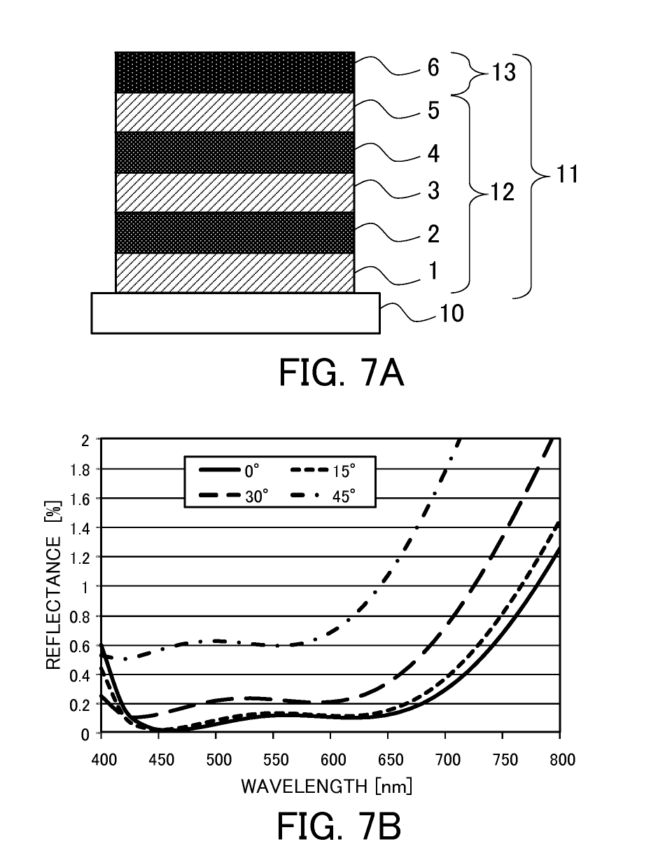

FIG. 7A is a schematic sectional view of an optical element of a comparative example to the first embodiment. The six-layered antireflection film 11 is laminated on the glass substrate 10 having a refractive index of 1.52. Hereinafter, values of a refractive index and an optical film thickness are obtained for λ of 550 nm.

Table 2 shows design values of the antireflection film according to the comparative example. The multilayer film layer 12 including the first layer 1 to the fifth layer 5 is formed by the evaporation method. They are made of the same materials and the same film thickness as those of the first embodiment. The sixth layer 6 (the hollow-particle layer 13) uses SiO₂ for the hollow particle and the film thickness is 132.9 nm.

The close-packed arrangement formed by using the hollow particles of the same diameter 43 nm as that of the first embodiment has a thickness of 113 nm in the three layers and a thickness of 148 nm in the four layers. Thereby, the film thickness significantly shifts from the design value. If the film thickness of the four-layered configuration is forced to be equal to the designed value, the filling rate needs to be 65% or less. The filling rate of 65% or less is usually insufficient to maintain the regular arrangement and causes scattering.

FIG. 7B is a graph of a wavelength characteristic of a reflectance of the antireflection film according to the comparative example, and shows simulation results with incident angles of 0°, 15°, 30°, and 45° in a wavelength range of 400 nm to 800 nm. In the comparative example, at the incident angle of 0°, the wavelength range of the reflectance of 0.2% or less is from 430 nm to 670 nm and becomes narrower than that of the first embodiment. The wavelength range of 0.6% or less corresponding to the reflectance at the incident angle of 30° is 680 nm or less and deteriorated. Even if the hollow-particle layer is formed as designed, the first embodiment is superior both in a wavelength characteristic and in an incident angle characteristic.

TABLE 2

| | refractive index | optical film |
|---|---|---|
| | (550 nm) | thickness (nm) |
| seventh layer | 1.48 | 0.0 |
| sixth layer | 1.25 | 132.9 |
| fifth layer | 1.48 | 12.3 |
| fourth layer | 2.10 | 23.3 |
| third layer | 1.65 | 121.8 |
| second layer | 2.10 | 30.4 |
| first layer | 1.65 | 144.4 |
| substrate layer | 1.52 | |

### Second Embodiment

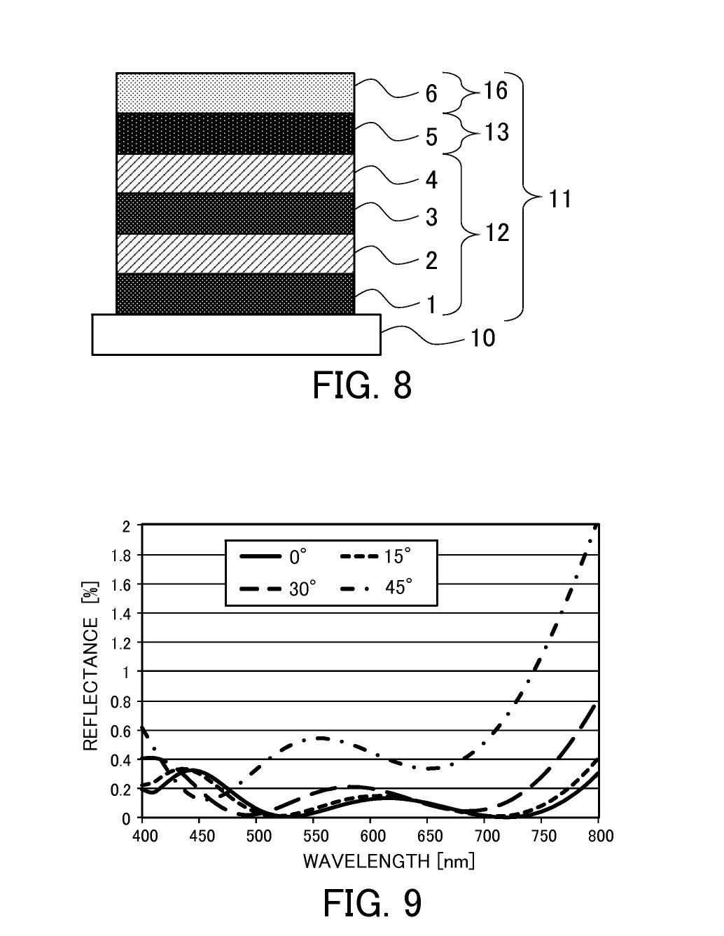

A second embodiment equalizes the thickness of the hollow-particle layer 13 for a plurality of substrate refractive indices. FIG. 8 illustrates a schematic sectional view of an optical element according to the second embodiment. In the optical element, the six-layered antireflection film is laminated on each of different types of the substrate 10 (with refractive indices of 1.50, 1.60, 1.70, 1.80, and 1.90) as a glass substrate.

Table 3 shows design values of the antireflection film 11 for each substrate refractive index according to the second embodiment. The multilayer film layer 12 including the first layer 1 to the fourth layer 4 is formed by the evaporation method, and each layer thicknesses is different according to the substrate refractive indices. The fifth layer 5 (the hollow-particle layer 13) uses SiO₂ for the outer shell 15a in the hollow particle. The hollow particles have an average diameter of 46.3 nm, and are laminated in the double-layered close-packed state. The binder is mainly composed of SiO₂ and fills the space in the hollow particles 14. The hollow-particle layer 13 has a refractive index of about 1.20 and a thickness of about 84.1 nm. This layer has a film thickness common to each of the substrate refractive indices. The sixth layer 6 (the film thickness coordination layer 16) is formed by evaporating silica.

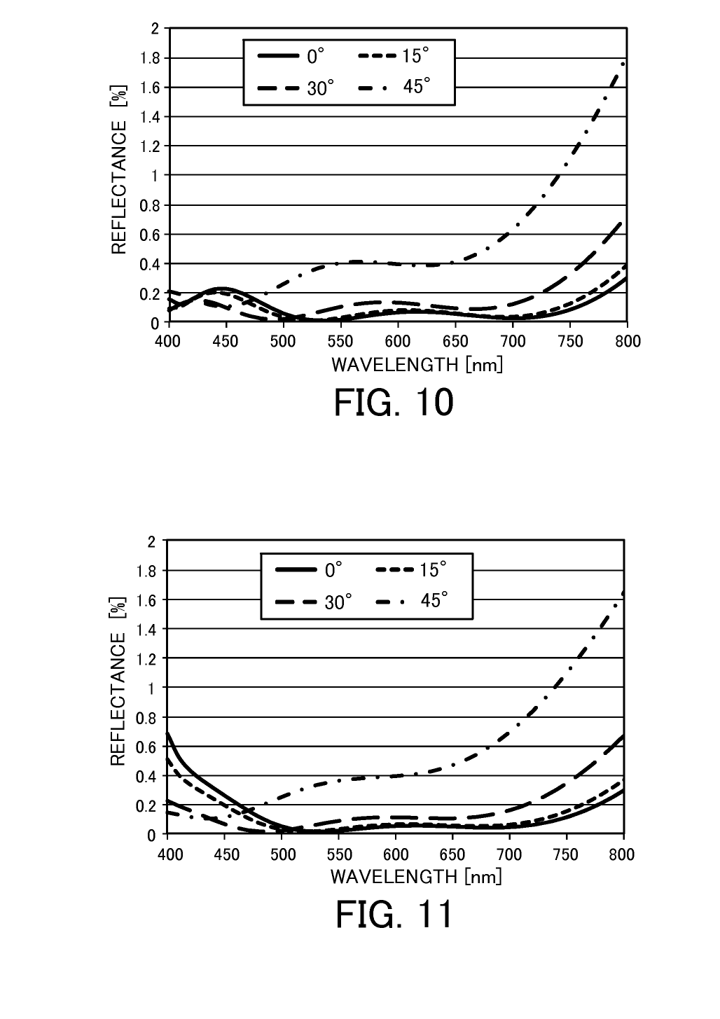

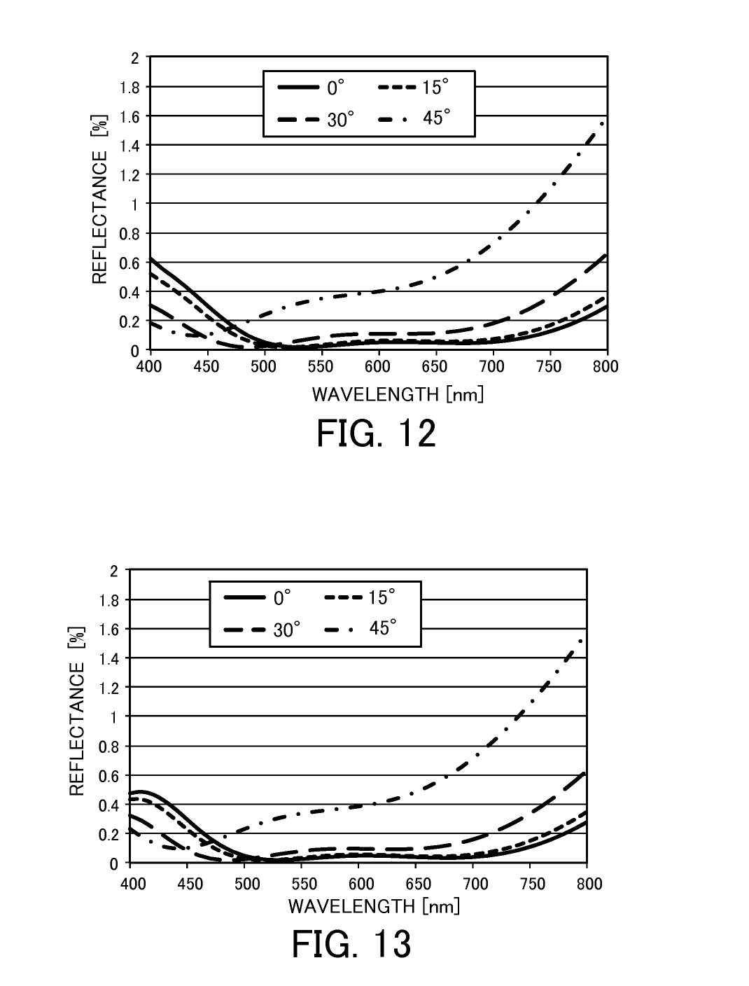

FIGS. 9 to 13 are graphs of a wavelength characteristic of a reflectance of the antireflection film 11 laminated on the substrate 10 with the refractive indices of 1.5 to 1.9 according to the second embodiment, respectively and show simulation results with incident angles of 0°, 15°, 30°, and 45° in a wavelength range of 400 nm to 800 nm. FIG. 9 corresponds to the substrate 10 with the refractive index of 1.5. FIG. 10 corresponds to the substrate 10 with the refractive index of 1.6. FIG. 11 corresponds to the substrate 10 with the refractive index 1.7. FIG. 12 corresponds to the substrate 10 with the refractive index 1.8. FIG. 13 corresponds to the substrate 10 with the refractive index 1.9. In the wavelength range between 420 nm and 700 nm, the reflectances with the incident angles of 0°, 15°, and 30° are 0.5% or less, and a high-performance antireflection characteristic is obtained. For a wide range of glass materials with substrate refractive indices from 1.50 to 1.90, this embodiment can provide a high-performance antireflection film to the hollow-particle layer of the same film thickness coated with the same film material under the same condition.

TABLE 3

| | refractive | | | | | |
|---|---|---|---|---|---|---|
| | index | substrate refractive index | | | | |
| | (550 nm) | 1.50 | 1.60 | 1.70 | 1.80 | 1.90 |
| sixth | 1.48 | 10.4 | 13.0 | 14.3 | 13.5 | 12.0 |
| layer | | | | | | |
| fifth | 1.20 | 84.1 | 84.1 | 84.1 | 84.1 | 84.1 |
| layer | | | | | | |
| fourth | 1.65 | 100.9 | 106.1 | 107.8 | 100.1 | 90.9 |
| layer | | | | | | |
| third | 2.10 | 26.6 | 21.7 | 21.6 | 24.9 | 30.8 |
| layer | | | | | | |
| second | 1.65 | 68.0 | 59.9 | 46.8 | 34.5 | 24.4 |
| layer | | | | | | |
| first | 2.10 | 10.3 | 10.6 | 12.1 | 16.7 | 25.2 |
| layer | | | | | | |

### Third Embodiment

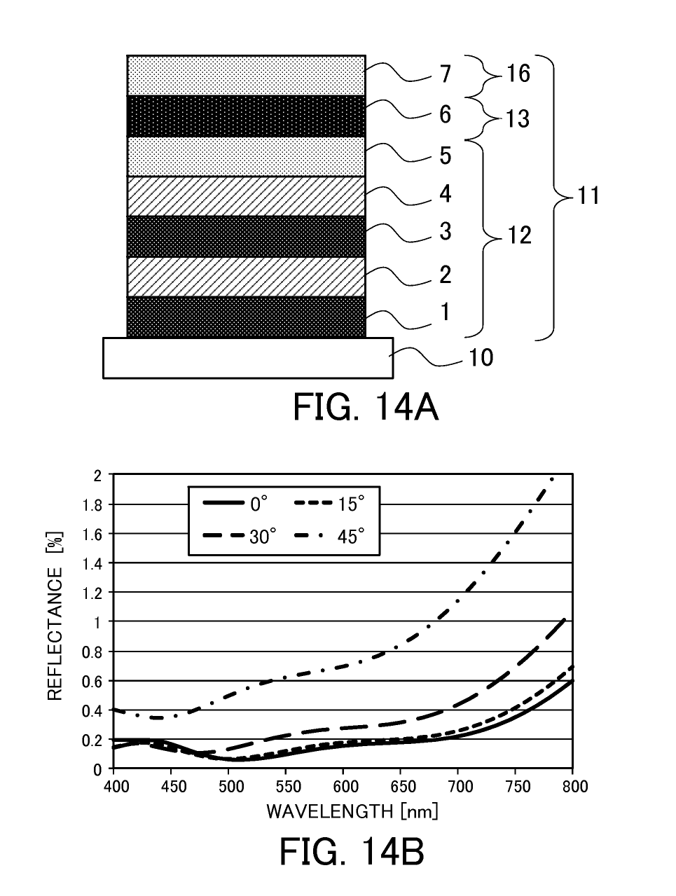

FIG. 14A is a schematic sectional view of an optical element according to a third embodiment. The seven-layered antireflection film 11 is laminated on the substrate 10 as a glass substrate having a refractive index of 1.61. Hereinafter, values of a refractive index and an optical film thickness are obtained for λ of 550 nm.

Table 4 shows design values of the antireflection film 11 according to the third embodiment. The multilayer film layer 12 including the first layer 1 to the fifth layer 5 is formed by the evaporation method. The sixth layer 6 (the hollow-particle layer 13) uses SiO₂ for the outer shell 15a in the hollow particle 14, the hollow particle 14 has an average diameter of 40.9 nm, and the hollow particles 14 are laminated in the triple-layered close-packed state. The binder 17 is mainly composed of SiO₂ and fills the space in the hollow particles 14. The hollow-particle layer 13 has a refractive index of about 1.25 and a thickness of about 107.7 nm. The seventh layer 7 (the film thickness coordination layer 16) is formed by evaporating silica.

FIG. 14B is a graph of a wavelength characteristic of a reflectance of the antireflection film according to the third embodiment, and shows the simulation results with incident angles of 0°, 15°, 30°, and 45° in a wavelength range between 400 nm and 800 nm. In the wavelength range between 400 nm and 700 nm, the reflectances with the incident angles of 0°, 15°, and 30° are 0.5% or less, and a high-performance antireflection characteristic is obtained.

TABLE 4

| | refractive index | optical film |
|---|---|---|
| | (550 nm) | thickness (nm) |
| seventh layer | 1.48 | 12.0 |
| sixth layer | 1.25 | 107.7 |
| fifth layer | 1.48 | 13.0 |
| fourth layer | 1.65 | 177.9 |
| third layer | 2.10 | 22.7 |
| second layer | 1.65 | 108.9 |
| first layer | 2.10 | 10.0 |
| substrate layer | 1.61 | |

### Fourth Embodiment

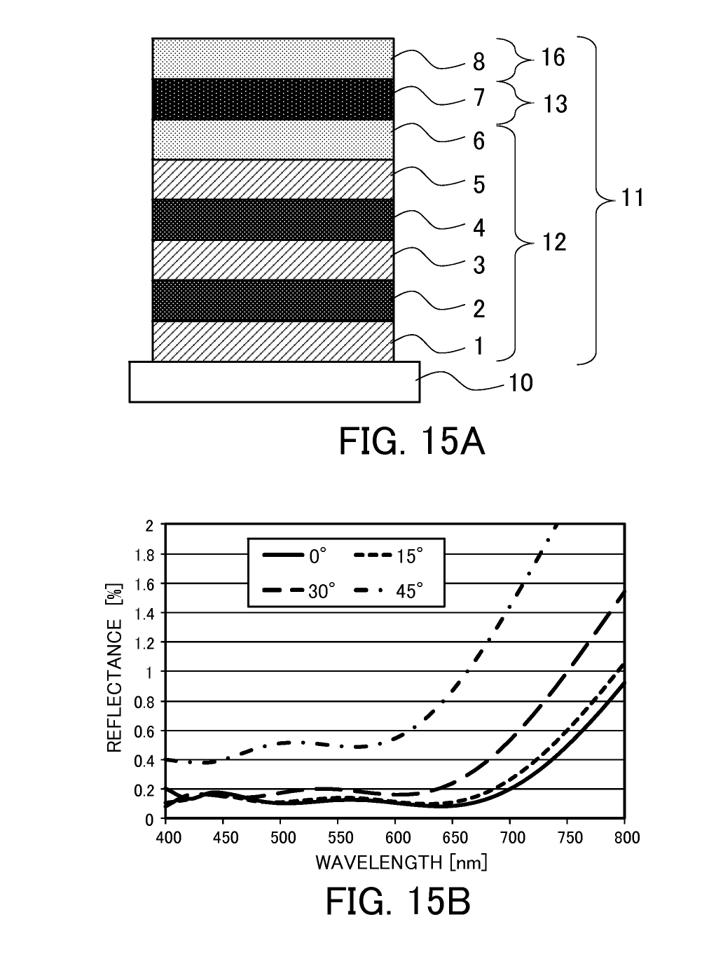

FIG. 15A is a schematic sectional view of an optical element according to a fourth embodiment. The eight-layered antireflection film 11 is laminated on the substrate 10 as a glass substrate with a refractive index 1.73. Hereinafter, values of a refractive index and an optical film thickness are obtained for λ of 550 nm.

Table 5 shows design values of the antireflection film 11 according to the fourth embodiment. The multilayer film layer 12 including the first layer 1 to the sixth layer 6 is formed by the evaporation method. The seventh layer 7 (the hollow-particle layer 13) uses SiO₂ for the outer shell 15a in the hollow particles 14, the hollow particle 14 has an average diameter of 38.9 nm, and the hollow particles 14 are laminated in the triple-layered close-packed state. The binder 17 is mainly composed of SiO₂ and fills the space in the hollow particles 14. The hollow-particle layer 13 has a refractive index of about 1.25 and a thickness of about 102.4 nm. The eighth layer 8 (the film thickness coordination layer 16) is formed by evaporating silica.

FIG. 15B is a graph of a wavelength characteristic of a reflectance of the antireflection film 11 according to the fourth embodiment, and shows simulation results in incident angles of 0°, 15°, 30°, and 45° in a wavelength range between 400 nm and 800 nm. In the wavelength range between 400 nm and 700 nm, the reflectances with the incident angles of 0° and 15° are 0.3% or less, the reflectance with the incident angle of 45° is 1.5% or less, and a high-performance antireflection characteristic is obtained.

TABLE 5

| | refractive index | optical film |
|---|---|---|
| | (550 nm) | thickness (nm) |
| eighth layer | 1.48 | 15.0 |
| seventh layer | 1.25 | 102.4 |
| sixth layer | 1.48 | 20.0 |
| fifth layer | 1.65 | 186.4 |
| fourth layer | 2.10 | 19.6 |
| third layer | 1.65 | 148.5 |
| second layer | 2.10 | 12.0 |
| first layer | 1.65 | 78.3 |
| substrate layer | 1.73 | |

### Fifth Embodiment

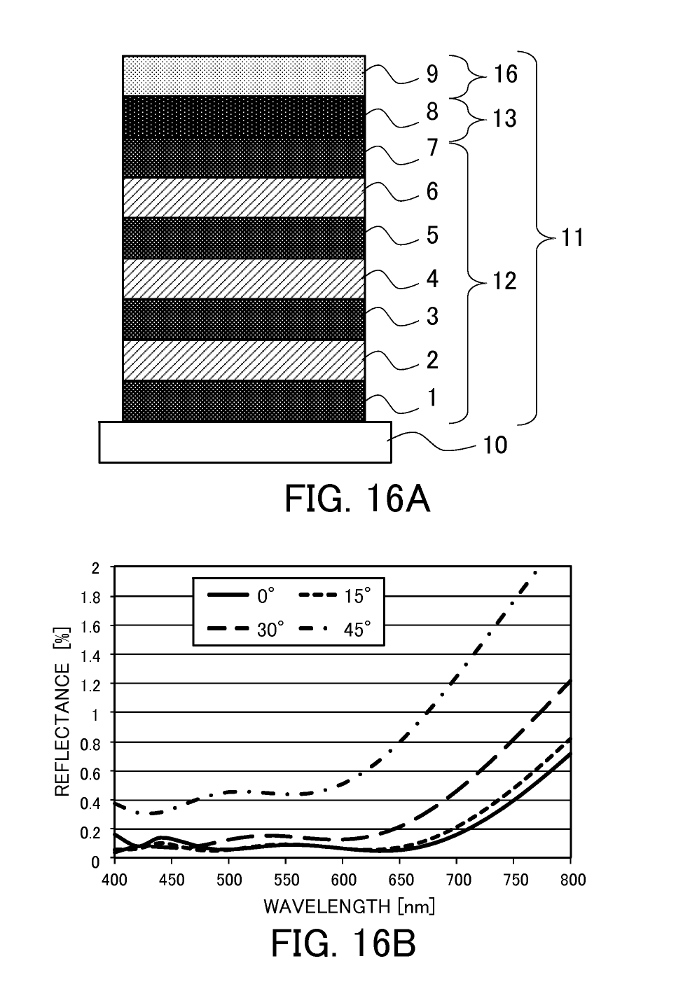

FIG. 16A is a schematic sectional view of an optical element according to a fifth embodiment. The nine-layered antireflection film 11 is laminated on the substrate 10 as a glass substrate with a refractive index 1.89. Hereinafter, values of a refractive index and an optical film thickness are obtained for λ of 550 nm.

Table 6 shows design values of the antireflection film 11 according to the fifth embodiment. The multilayer film layer 12 including the first layer 1 to the seventh layer 7 is formed by the evaporation method. The eighth layer 8 (the hollow-particle layer 13) uses SiO₂ for the outer shell 15a in the hollow particle 14, the hollow particle 14 has an average diameter of 48.0 nm, and the hollow particles 14 are laminated in the triple-layered close-packed state. The binder 17 is mainly composed of SiO₂ and fills the space in the hollow particles 14. The hollow-particle layer 13 has a refractive index of about 1.25 and a thickness of about 126.4 nm. Silica of the ninth layer 9 (the film thickness coordination layer 16) is formed by a wet process of the sol-gel method. This process may be performed simultaneously with embedding the binder.

FIG. 16B is a graph of a wavelength characteristic of a reflectance of the antireflection film 11 according to the fifth embodiment, and show the simulation results with incident angles of 0°, 15°, 30°, and 45° in a wavelength range between 400 nm and 800 nm. In the wavelength range between 400 nm and 800 nm, the reflectances with the incident angles of 0° and 15° are 0.2% or less, the reflectance with the incident angle of 45° is 1.3% or less, and a high-performance antireflection characteristic is obtained.

TABLE 6

| | refractive index | optical film |
|---|---|---|
| | (550 nm) | thickness (nm) |
| ninth layer | 1.48 | 15.0 |
| eighth layer | 1.25 | 126.4 |
| seventh layer | 2.10 | 20.0 |
| sixth layer | 1.65 | 141.4 |
| fifth layer | 2.10 | 46.9 |
| fourth layer | 1.65 | 90.5 |
| third layer | 2.10 | 44.3 |
| second layer | 1.65 | 68.4 |
| first layer | 2.10 | 15.0 |
| subtrate layer | 1.89 | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. An optical element (lens) including the antireflection film according to the embodiment, an optical element having the optical element, and an optical apparatus having the optical element, such as an image-pickup apparatus, a microscope, a binocular, a projection type display apparatus, constitute part of the present invention.

This application claims the benefit of Japanese Patent Application No. 2013-129006, filed Jun. 19, 2013, which is hereby incorporated by reference herein in their entirety.

What is claimed is:

1. An optical element comprising: a substrate; and an antireflection film laminated on the substrate,
wherein the antireflection film includes, in order from the substrate side, a first layer including a plurality of dielectric thin films, a second layer including hollow particles bound by a dielectric material, and a third layer laminated on the second layer and made of a homogeneous dielectric,
wherein the hollow particles have an average particle diameter of 60 nm or less, and
wherein a filling rate of the hollow particles in the second layer is 65% or higher.

2. The optical element according to claim 1, wherein the following expressions are satisfied:
$$\begin{matrix}0.80 \leq {h}_{1} / ( a + \frac{\sqrt{6}}{3} a \times n ) \leq 1.10 \\ 5 ( nm ) \leq {h}_{2} \leq \frac{\sqrt{6}}{3} a\end{matrix}$$
where a is the average particle diameter of the hollow particles, h₁ is a thickness of the second layer, h₂ is a thickness of the third layer, and n is a natural number (n=1, 2, 3, . . . ).

3. The optical element according to claim 2, wherein the following expression is satisfied:
$$\frac{a}{4} \leq {h}_{2} \leq \frac{\sqrt{6}}{3} a .$$

4. The optical element according to claim 3, wherein the following expression is satisfied:
$$\frac{a}{2} \leq {h}_{2} \leq \frac{\sqrt{6}}{3} a .$$

5. The optical element according to claim 2, wherein the following expression is satisfied where R is the filling rate of the hollow particles:
$$0.95 \leq {h}_{1} / ( a + \frac{\sqrt{6}}{3} a \times n \times ( 1 + 0.7054 \times ( R - 0.74 ) ) ) \leq 1.05 .$$

6. The optical element according to claim 2, wherein the following expression is satisfied where n1 is a refractive index of the second layer for a wavelength of 550 nm, and n2 is a refractive index of the third layer for a wavelength of 550 nm:
100 (nm)<n1×h₁+n2×h₂<150 (nm).

7. The optical element according to claim 2, wherein the hollow particle includes an outer shell made of SiO₂, a cavity included in the outer shell, and a percentage of the cavity in the hollow particle is between 30% and 70%, inclusive.

8. The optical element according to claim 7, wherein the dielectric material in the second layer binds the hollow particles with one another and is made of SiO₂ as a major component.

9. The optical element according to claim 8, wherein the third layer is made of SiO₂ as a major component.

10. The optical element according to claim 9, wherein the third layer is formed by a wet process.

11. The optical element according to claim 9, wherein the third layer is formed by a dry process.

12. An optical system comprising an optical element that includes a substrate, and an antireflection film laminated on the substrate,
wherein the antireflection film includes, in order from the substrate side, a first layer including a plurality of dielectric thin films, a second layer including hollow particles bound by a dielectric material, and a third layer laminated on the second layer and made of a homogeneous dielectric,
wherein the hollow particles have an average particle diameter of 60 nm or less, and
wherein a filling rate of the hollow particles in the second layer is 65% or higher.

13. An optical apparatus comprising an optical element that includes a substrate, and an antireflection film laminated on the substrate,
wherein the antireflection film includes, in order from the substrate side, a first layer including a plurality of dielectric thin films, a second layer including hollow particles bound by a dielectric material, and a third layer laminated on the second layer and made of a homogeneous dielectric,
wherein the hollow particles have an average particle diameter of 60 nm or less, and
wherein a filling rate of the hollow particles in the second layer is 65% or higher.
